(19) United States
(12) Patent Application Publication
(10) Pub. No.: US 2013/0090081 A1
(43) Pub. Date: Apr. 11, 2013

(54) APPARATUS AND METHOD FOR PROVIDING EMERGENCY CALL IN MOBILE COMMUNICATION SYSTEM

(71) Applicant: Samsung Electronics Co., Ltd., Suwon-si (KR)

(72) Inventors: Han-Na LIM, Seoul (KR); Song-Yean CHO, Seoul (KR); Beom-Sik BAE, Suwon-si (KR); Jung-Je SON, Yongin-si (KR); Sang-Soo JEONG, Suwon-si (KR)

(73) Assignee: SAMSUNG ELECTRONICS CO., LTD., Suwon-si (KR)

(21) Appl. No.: 13/648,616

(22) Filed: Oct. 10, 2012

(30) Foreign Application Priority Data
Oct. 10, 2011 (KR) 10-2011-0103317

(51) Int. Cl. H04W 4/22

(52) U.S. Cl. 455/404.1

(57) ABSTRACT

An apparatus and method for providing an emergency call in a mobile communication system are provided. In the method, a User Equipment (UE) transmits, to a Proxy-Call Session Control Function (P-CSCF) entity, a first message including first information indicating that the UE requests an emergency call and receives, from the P-CSCF entity a second message including second information indicating whether a serving Public Land Mobile Network (PLMN) supports a Non Voice Emergency Service (NOVES), and indicating a media type which the serving PLMN supports.

### PRIORITY

This application claims the benefit under 35 U.S.C. §119(a) of a Korean Patent Application filed on Oct. 10, 2011 in the Korean Intellectual Property Office and assigned Serial No. 10-2011-0103317, the entire disclosure of which is hereby incorporated by reference.

### BACKGROUND OF THE INVENTION

1. Field of the Invention

The present invention relates to an apparatus and method for providing an emergency call in a mobile communication system. More particularly, the present invention relates to an apparatus and method for providing an emergency call according to a Non Voice Emergency Service (NOVES) in a mobile communication system.

2. Description of the Related Art

A mobile communication according to the related art provides a voice-type emergency call. However, there is a need for a service providing a non voice type-emergency call as packet communication systems have developed, and smart phones are being commonly used. A proposed service according to the need is a Non Voice Emergency Service (NOVES). The NOVES provides a non-voice type-emergency call, i.e., a NOVES call indicating a media type-emergency call, such as a video streaming type-emergency call and a text-type emergency call.

However, mobile communication systems that have been proposed up to now may not be able to determine whether a serving Public Land Mobile Network (PLMN) which User Equipment (UE) accesses supports a NOVES even though the UE requests a NOVES call. As a result, there is a possibility that the request for the NOVES call by the UE may fail. The mobile communication systems that have been proposed up to now may not be able to determine a media type(s) which the serving PLMN supports even though the serving PLMN supports the NOVES. A media type of the NOVES call requested by the UE may be different from a media type which a related access network supports. In this case, there is a possibility that the UE may not be provided with the NOVES call.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for providing an emergency call in a mobile communication system.

Another aspect of the present invention is to provide an emergency call provision apparatus and method for notifying whether a serving Public Land Mobile Network (PLMN) supports a Non Voice Emergency Service (NOVES) in a mobile communication system.

Another aspect of the present invention is to provide an emergency call provision apparatus and method for notifying a media type supported in a serving PLMN in a mobile communication system.

In accordance with an aspect of the present invention, a User Equipment (UE) in a mobile communication system is provided. The UE includes a transmitter for transmitting, to a Proxy-Call Session Control Function (P-CSCF) entity, a first message including first information indicating that the UE requests an emergency call, and a receiver for receiving, from the P-CSCF entity, a second message including second information indicating whether a serving PLMN supports a NOVES, and indicating a media type which the serving PLMN supports.

In accordance with another aspect of the present invention, a Home Subscriber Server (HSS) in a mobile communication system is provided. The HSS includes a controller for performing an authentication process with a Serving-Call Session Control Function (S-CSCF) entity if the S-CSCF entity receives a first message including first information indicating that a UE requests an emergency call, and a transmitter for transmitting a second message including second information indicating whether a serving PLMN supports a NOVES, and indicating a media type which the serving PLMN supports to the S-CSCF entity if the authentication process succeeds.

In accordance with another aspect of the present invention, a User Equipment (UE) in a mobile communication system is provided. The UE includes a transmitter for transmitting, to a P-CSCF entity one of a first message including information indicating that the UE requests an emergency call and supports a NOVES, and a second message including information indicating that the UE requests the emergency call and supports the NOVES, and indicating a media type of a NOVES call which the UE wants to connect, and a receiver for receiving a third message including information indicating a media type which a serving PLMN supports from the P-CSCF entity if the first message is transmitted, and for receiving a fourth message including information indicating Visited Public Land Mobile Networks (VPLMNs) supporting the media type from the P-CSCF entity if the second message is transmitted.

In accordance with another aspect of the present invention, an HSS in a mobile communication system is provided. The HSS includes a controller for performing an authentication process with a home S-CSCF entity if one of a first message including information indicating that a UE requests an emergency call and supports a NOVES, and a second message including information indicating that the UE requests the emergency call and supports the NOVES, and indicating a media type of a NOVES call which the UE wants to connect is received at the home S-CSCF entity, and a transmitter for transmitting a third message including information indicating a media type which a serving PLMN supports to the home S-CSCF entity if the first message is received and the authentication process fails, and for transmitting a fourth message including a VPLMN list including information on VPLMNs supporting the media type to the home S-CSCF entity if the second message is received and the authentication process succeeds.

In accordance with another aspect of the present invention, a method for receiving an emergency call by a UE in a mobile communication system is provided. The method includes transmitting, to a P-CSCF entity, a first message including first information indicating that the UE requests an emergency call, and receiving, from the P-CSCF entity, a second message including second information indicating whether a serving PLMN supports a NOVES, and indicating a media type which the serving PLMN supports.

In accordance with another aspect of the present invention, method for providing an emergency call by an HSS in a mobile communication system is provided. The method includes performing an authentication process with an S-CSCF entity if the S-CSCF entity receives a first message including first information indicating that a UE requests an emergency call, and if the authentication process succeeds, transmitting, to the S-CSCF entity, a second message including second information indicating whether a serving PLMN supports a NOVES, and indicating a media type which the serving PLMN supports.

In accordance with another aspect of the present invention, a method for receiving an emergency call by a UE in a mobile communication system is provided. The method includes transmitting, to a P-CSCF entity, one of a first message including information indicating that the UE requests an emergency call and supports a NOVES, and a second message including information indicating that the UE requests the emergency call and supports the NOVES, and indicating a media type of a NOVES call which the UE wants to connect, receiving a third message including information indicating a media type which a serving PLMN supports from the P-CSCF entity if the first message is transmitted, and receiving a fourth message including information indicating VPLMNs supporting the media type from the P-CSCF entity if the second message is transmitted.

In accordance with another aspect of the present invention, a method for providing an emergency call by an HSS in a mobile communication system is provided. The method includes performing an authentication process with a home S-CSCF entity if one of a first message including information indicating that a UE requests an emergency call and supports a NOVES, and a second message including information indicating that the UE requests the emergency call and supports the NOVES, and indicating a media type of a NOVES call which the UE wants to connect is received at the home S-CSCF entity, transmitting a third message including information indicating a media type which a serving PLMN supports to the home S-CSCF entity if the first message is received and the authentication process fails, and transmitting a fourth message including a VPLMN list including information on VPLMNs supporting the media type to the home S-CSCF entity if the second message is received and the authentication process succeeds.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 schematically illustrates an Internet Protocol Multimedia Subsystem (IMS) according to an exemplary embodiment of the present invention;

FIG. 2 is a signal flow diagram schematically illustrating an emergency call provision process for notifying whether a serving Public Land Mobile Network (PLMN) supports a Non Voice Emergency Service (NOVES), and a media type which the serving PLMN supports if the serving PLMN supports the NOVES in an IMS according to a first exemplary embodiment of the present invention;

FIG. 3 is a signal flow diagram schematically illustrating an emergency call provision process for notifying a media type which a serving PLMN supports if an authentication process fails in an IMS according to a second exemplary embodiment of the present invention;

FIG. 4 is a signal flow diagram schematically illustrating an emergency call provision process for notifying whether a serving PLMN supports a NOVES, and a media type which the serving PLMN supports if the serving PLMN supports the NOVES in an IMS according to a third exemplary embodiment of the present invention;

FIG. 5 is a signal flow diagram schematically illustrating an emergency call provision process for notifying whether a serving PLMN supports a NOVES, and a media type which the serving PLMN supports if the serving PLMN supports the NOVES in an IMS according to a fourth exemplary embodiment of the present invention;

FIG. 6 is a block diagram schematically illustrating an internal structure of a UE in an IMS according to an exemplary embodiment of the present invention;

FIG. 7 is a block diagram schematically illustrating an internal structure of a Proxy-Call Session Control Function (P-CSCF) entity in an IMS according to an exemplary embodiment of the present invention;

FIG. 8 is a block diagram schematically illustrating an internal structure of a home Serving-Call Session Control Function (S-CSCF) entity in an IMS according to an exemplary embodiment\ of the present invention; and

FIG. 9 is a block diagram schematically illustrating an internal structure of an HSS in an IMS according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide an apparatus and method for providing an emergency call in a mobile communication system. Another exemplary embodiment of the present invention provides an emergency call provision apparatus and method for notifying whether a serving Public Land Mobile Network (PLMN) supports a Non Voice Emergency Service (NOVES) in a mobile communication system. Another exemplary embodiment of the present invention provides an emergency call provision apparatus and method for notifying a media type which a serving PLMN supports if the serving PLMN supports the NOVES in a mobile communication system.

Exemplary embodiments of the present invention will be described below with reference to a mobile communication system, for example, an Internet Protocol (IP) Multimedia Subsystem (IMS). However, it will be understood that the mobile communication system may be any one of an Evolved Packet System (EPS), a Long-Term Evolution (LTE) mobile communication system, a Long-Term Evolution Advanced (LTE-A) mobile communication system, and an Institute of Electrical and Electronics Engineers (IEEE) 802.16m mobile communication system as well as the IMS.

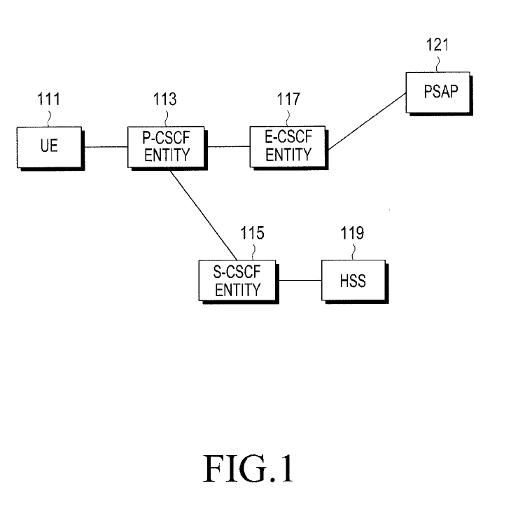

FIG. 1 schematically illustrates an IMS according to an exemplary embodiment of the present invention.

Referring to FIG. 1, the IMS includes a User Equipment (UE) 111, a Proxy-Call Session Control Function (CSCF) (P-CSCF) entity 113, a Serving-CSCF (S-CSCF) entity 115, an Emergency-CSCF (E-CSCF) entity 117, a Home Subscriber Server (HSS) entity 119, and a Public Safety Answering Point (PSAP) 121.

The P-CSCF entity 113 is an entity which the UE 111 firstly and lastly accesses on an incoming call and an outgoing call. The S-CSCF entity 115 controls a normal call. The E-CSCF entity 117 controls an emergency call, searches the nearest PSPA from the E-CSCF entity 117 upon receiving an emergency call request from the P-CSCF entity 113, and routes an emergency call to the searched PSAP, i.e., the PSAP 121.

The UE 111 transmits an INVITE message including a sos-urn as a parameter indicating an emergency call to the P-CSCF entity 113 in order to request the emergency call. The P-CSCF entity 113 determines that the UE 111 requests the emergency call according to the sos-urn included in the INVITE message, and transmits a call request to the E-CSCF entity 117. The E-CSCF entity 117 routes the emergency call to the nearest PSAP, i.e., the PSAP 121 using location information of the UE 111, a policy of a service provider, and the like.

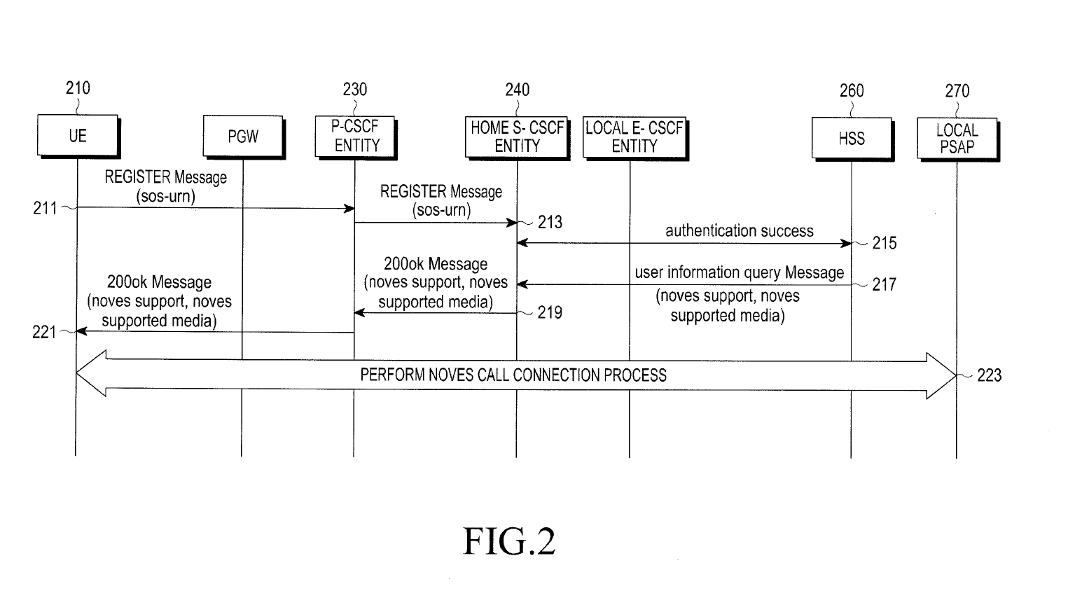

FIG. 2 is a signal flow diagram schematically illustrating an emergency call provision process for notifying whether a serving PLMN supports a NOVES, and a media type which the serving PLMN supports if the serving PLMN supports the NOVES in an IMS according to a first exemplary embodiment of the present invention.

Referring to FIG. 2, a UE 210 transmits a REGISTER message in order to request an IMS emergency registration to a P-CSCF entity 230 in step 211. The REGISTER message includes a sos-urn. After receiving the REGISTER message from the UE 210, the P-CSCF entity 230 transmits a REGISTER message to a home S-CSCF entity 240 in step 213. After the REGISTER message from the P-CSCF entity 230, the home S-CSCF entity 240 performs an authentication process with an HSS 260, so the authentication process succeeds in step 215.

The HSS 260 determines whether a serving PLMN of the UE 210 supports a NOVES, and determines a media type which the serving PLMN supports if the serving PLMN supports the NOVES. The HSS 260 transmits a user information query message including a user information query including a noves support as a parameter indicating whether the serving PLMN supports a NOVES, and a noves supported media as a parameter indicating a media type which the serving PLMN supports in step 217.

In FIG. 2, the user information query includes the noves support and the noves supported media. However, it will be understood that the user information query message need not include the noves supported media if the serving PLMN does not support the NOVES.

While a parameter indicating whether a serving PLMN supports a NOVES and a parameter indicating a media type which the serving PLMN supports are implemented in FIG. 2 as separate parameters, i.e., a noves support and noves supported media, it is to be understood that this is for merely convenience of description. The noves support and the noves supported media may be implemented as a single parameter.

After receiving the user information query message from the HSS 260, the home S-CSCF entity 240 transmits a 200ok message including the noves support and the noves supported media to the P-CSCF entity 230 in step 219. After receiving the 200ok message, the P-CSCF entity 230 transmits a 200ok message including the noves support and the noves supported media to the UE 210 in step 221.

After receiving the 200ok message from the P-CSCF entity 230, the UE 210 may determine whether a serving PLMN supports a NOVES, and a media type which the serving PLMN supports if the serving PLMN supports the NOVES according to the noves support and the noves supported media included in the 200ok message. After determining whether the serving PLMN supports the NOVES, and the media type which the serving PLMN supports if the serving PLMN supports the NOVES, the UE 210 performs a NOVES call connection process with a local PSAP 270 in step 223. The detailed description for the NOVES call connection process will be omitted.

As described above, the UE 210 may determine whether the serving PLMN supports the NOVES, and the media type which the serving PLMN supports if the serving PLMN supports the NOVES based on the noves support and the noves supported media included in the 200ok message.

If a media type of a NOVES call which the UE 210 wants is different from the media type determined based on the noves supported media, the UE 210 performs a PLMN re-selection process for selecting the other PLMN without an additional process.

The UE 210 may determine a need for performing a PLMN re-selection process when the UE 210 receives the 200ok message without trying to connect to a NOVES call, determining that a serving PLMN does not support a NOVES call with a media type which the UE 210 wants to receive by receiving a result of trying to connect to the NOVES call, and may determine a need for performing the PLMN re-selection process when the UE 210 determines that the serving PLMN does not support the NOVES call with the media type which the UE 210 wants to receive in a general IMS.

In the first exemplary embodiment of the present invention, the UE 210 does not have to perform every process necessary until the UE 210 determines to perform a PLMN re-selection process because an IMS according to the related art does not provide a NOVES call with a media type which the UE 210 wants, so a unnecessary signaling overhead may be prevented. The processes necessary until the UE 210 determines to perform a PLMN re-selection process may include a REGISTER message transmission/reception process, an authentication process, a user information detection process, a 200ok message transmission/reception process, an INVITE message transmission/reception process, a Session Description Protocol (SDP) answer message transmission/reception process, a BYE message transmission/reception process, and a 200ok message transmission/reception process. The detailed description for these processes will be omitted.

In the first exemplary embodiment of the present invention, as described above, a UE may determine whether a serving PLMN supports a NOVES and a media type which the serving PLMN supports if the serving PLMN supports the NOVES upon performing a registration process.

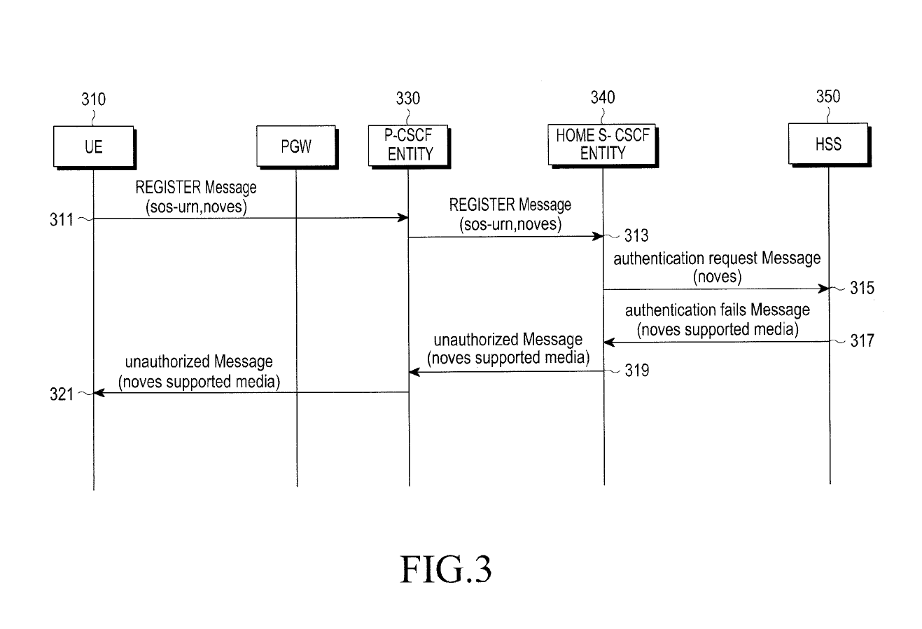

FIG. 3 is a signal flow diagram schematically illustrating an emergency call provision process for notifying a media type which a serving PLMN supports if an authentication process fails in an IMS according to a second exemplary embodiment of the present invention.

Referring to FIG. 3, a UE 310 transmits a REGISTER message in order to request an IMS emergency registration to a P-CSCF entity 330 in step 311. The REGISTER message includes a sos-urn and a noves as a parameter indicating that the UE 310 supports a NOVES. After receiving the REGISTER message from the UE 310, the P-CSCF entity 330 transmits a REGISTER message to a home S-CSCF entity 340 in step 313. After receiving the REGISTER message from the P-CSCF entity 330, the home S-CSCF entity 340 transmits an authentication request message to an HSS 350 in order to perform an authentication process with the HSS 350 in step 315. The authentication request message includes a noves.

After receiving the authentication request message from the home S-CSCF entity 340, the HSS 350 performs the authentication process, and transmits an authentication failure message as a response message to the authentication request message to the home S-CSCF entity 340 in step 317 if the authentication process failed. For example, the authentication process fails if the UE 310 does not include a Universal Subscriber Identity Module (USIM) or Internet Protocol Multimedia Services Identity Module (ISIM).

Even though the authentication process failed, the UE 310 supports a NOVES, so the HSS 350 transmits an authentication fails message including a noves supported media. The HSS 350 determines whether a serving PLMN supports a NOVES of the UE 310 even though the authentication process failed, and transmits the authentication fails message including the noves supported media if the serving PLMN supports the NOVES.

After receiving the authentication fails message from the HSS 350, the home S-CSCF entity 340 transmits an unauthorized message indicating that the authentication process is failed, and including the noves supported media to the P-CSCF entity 330 in step 319. After receiving the unauthorized message from the home S-CSCF entity 340, the P-CSCF entity 330 transmits an unauthorized message including a noves supported media to the UE 310 in step 321. After receiving the unauthorized message including the noves supported media, the UE 310 may determine a media type which a serving PLMN supports even though the authentication process is failed.

In this case, the UE 310 knows the media type which the serving PLMN supports, so may consider the media type if an authentication process is succeeded.

In the second exemplary embodiment of the present invention, as described above, a UE may identify a media type which a serving PLMN supports upon performing a registration process even though an authentication process failed.

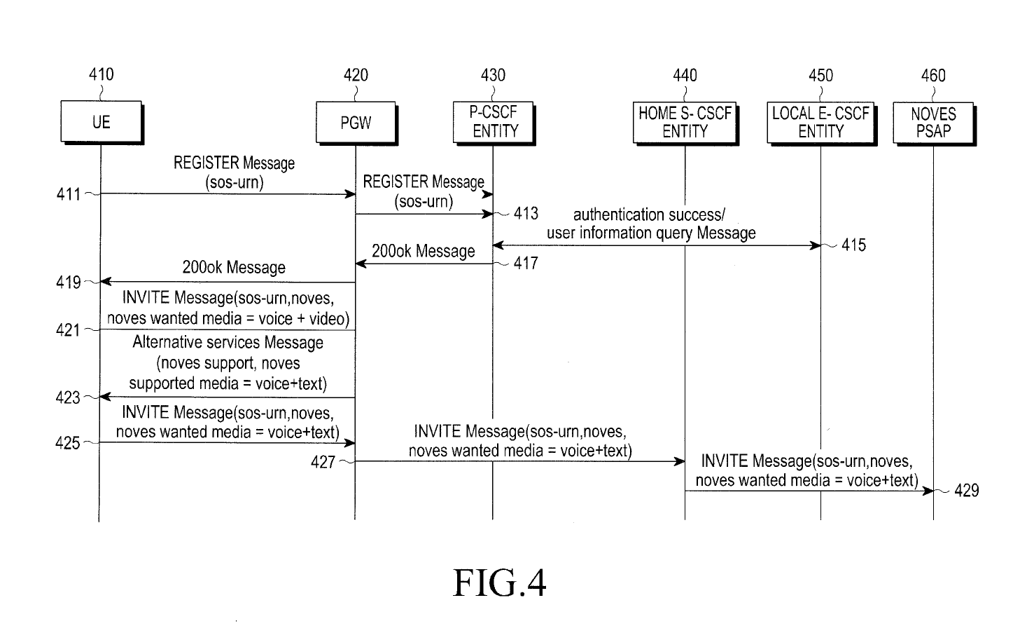

FIG. 4 is a signal flow diagram schematically illustrating an emergency call provision process for notifying whether a serving PLMN supports a NOVES, and a media type which the serving PLMN supports if the serving PLMN supports the NOVES in an IMS according to a third exemplary embodiment of the present invention.

Referring to FIG. 4, in the first and second exemplary embodiments of the present invention, a UE is notified whether a serving PLMN supports a NOVES and a media type which the serving PLMN supports if the serving PLMN supports the NOVES when the UE requests an IMS emergency registration, and not when the UE requests a NOVES call connection. In contrast, in the third exemplary embodiment of the present invention, a UE may be notified whether a serving PLMN supports a NOVES and a media type which the serving PLMN supports if the serving PLMN supports the NOVES when a UE requests a NOVES call connection, and not when the UE requests an IMS emergency registration.

A UE 410 transmits a REGISTER message to a P-CSCF entity 420 in order to request an IMS emergency registration in step 411. The REGISTER message includes a sos-urn. After receiving the REGISTER message from the UE 410, the P-CSCF entity 420 transmits a REGISTER message to a home S-CSCF entity 430 in step 413. The REGISTER message includes a sos-urn.

After receiving the REGISTER message from the P-CSCF entity 420, the home S-CSCF entity 430 performs an authentication process with an HSS 450, and receives a user information query in step 415 if the authentication process succeeds. The user information query includes general UE join information. After receiving the user information query, the home S-CSCF entity 430 transmits a 200ok message to the P-CSCF entity 420 in step 417. After receiving the 200ok message from the home S-CSCF entity 430, the P-CSCF entity 420 transmits a 200ok message to the UE 410 in step 419.

After the IMS emergency registration, the UE 410 transmits an INVITE message to the P-CSCF entity 420 in order to request a NOVES call in step 421. The INVITE message includes a sos-urn, a noves and a noves wanted media. The noves wanted media is a parameter indicating a media type of a NOVES call which the UE 410 wants to receive. In FIG. 4, it will be assumed that the noves wanted media indicates voice+video.

After receiving the INVITE message from the UE 410, the P-CSCF entity 420 transmits an Alternative services message as a response message to the INVITE message to the UE 410. The Alternative services message includes a noves support and a noves supported media. In FIG. 4, it will be assumed that the noves supported media indicates voice+text.

After receiving the Alternative services message from the P-CSCF entity 420, the UE 410 may determine whether a serving PLMN supports a NOVES, and a media type which the serving PLMN supports. The UE 410 may request a NOVES call connection according to the media type which the serving PLMN supports. In this case, the UE 410 transmits an INVITE message including a noves wanted media indicating the voice+text, a sos-urn, and a noves to the P-CSCF entity 420 in step 425.

After receiving the INVITE message from the UE 410, the P-CSCF entity 420 transmits an INVITE message including a noves wanted media indicating the voice+text, a sos-urn and a noves to a local E-CSCF entity 440 in step 427. After receiving the INVITE message, the local E-CSCF entity 440 transmits an INVITE message including a noves wanted media indicating the voice+text, a sos-urn and a noves to a NOVES PSAP 460 in step 429

As described above, the UE 410 may determine, based on the noves support and the noves supported media included in the Alternative services message, whether the serving PLMN supports the NOVES, and the media type which the serving PLMN supports if the serving PLMN supports the NOVES.

If a media type of a NOVES call which the UE 410 wants is different from the media type determined based on the noves supported media, the UE 410 performs a PLMN re-selection process for selecting the other PLMN without an additional process.

The UE 410 may determine that a PLMN re-selection process for selecting the other PLMN is necessary when the UE 410 receives an Alternative services message, not when the UE 410 determines that a serving PLMN does not support a NOVES call with a media type which the UE 410 wants after trying to connect the NOVES call and receiving the result for the NOVES call connection.

In the third exemplary embodiment of the present invention, the UE 410 does not have to perform every process necessary until the UE 410 determines to perform a PLMN re-selection process because an IMS according to the related art does not provide a NOVES call with a media type which the UE 410 wants, so a unnecessary signaling overhead may be prevented. The detailed description of these processes will be omitted.

In the third exemplary embodiment of the present invention, as described above, a UE may determine whether a serving PLMN supports a NOVES and a media type which the serving PLMN supports if the serving PLMN supports the NOVES.

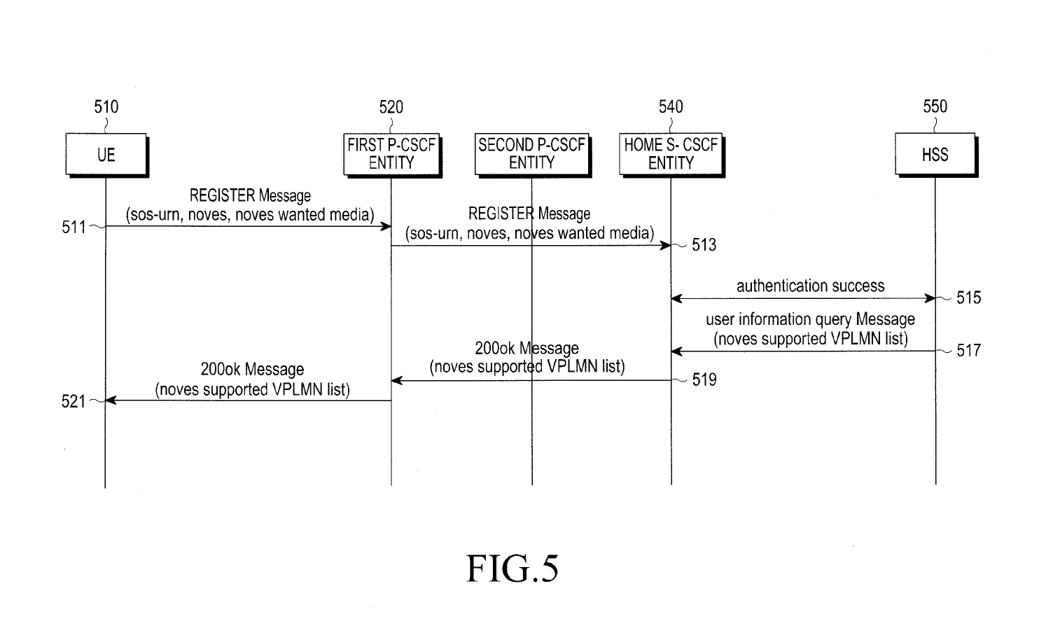

FIG. 5 is a signal flow diagram schematically illustrating an emergency call provision process for notifying whether a serving PLMN supports a NOVES, and a media type which the serving PLMN supports if the serving PLMN supports the NOVES in an IMS according to a fourth exemplary embodiment of the present invention.

Referring to FIG. 5, a UE 510 transmits a REGISTER message to the first P-CSCF entity 520 in order to request an IMS emergency registration in step 511. The REGISTER message includes a sos-urn, a noves and a noves wanted media. After receiving the REGISTER message from the UE 510, the first P-CSCF entity 520 transmits a REGISTER message to a home S-CSCF entity 540 in step 513. The REGISTER message transmitted from the first P-CSCF entity 520 to the home S-CSCF entity 540 includes a noves and noves wanted media.

After receiving the REGISTER message from the first P-CSCF entity 520, the home S-CSCF entity 540 performs an authentication process with an HSS 550 and the authentication process is succeeded in step 515. The HSS 550 identifies Visited PLMNs (VPLMNs) supporting a media type according to the noves wanted media, and generates a noves supported VPLMN list, i.e., a VPLMN list including the identified VPLMNs. The HSS 550 transmits a user information query message including a user information query including the noves supported VPLMN list to the home S-CSCF 540 in step 517.

After receiving the user information query message, the home S-CSCF entity 540 transmits a 200ok message including the noves supported VPLMN list to the first P-CSCF entity 520 in step 519. After receiving the 200ok message, the first P-CSCF entity 520 transmits a 200ok message including the noves supported VPLMN list to the UE 510 in step 521.

After receiving the 200ok message from the first P-CSCF entity 520, the UE 510 may identify VPLMNs supporting a media type which the UE 510 wants to receive according to the noves supported VPLMN list included in the 200ok message.

While not described in FIG. 5, the UE 510 may perform a NOVES call connection process to a desired VPLMN by determining a media type which the UE 510 wants to receive. The detailed description of the NOVES call connection process will be omitted.

In the fourth exemplary embodiment of the present invention, as described above, a UE may identify VPLMNs supporting a media type of a NOVES call which the UE wants to receive upon performing a registration process.

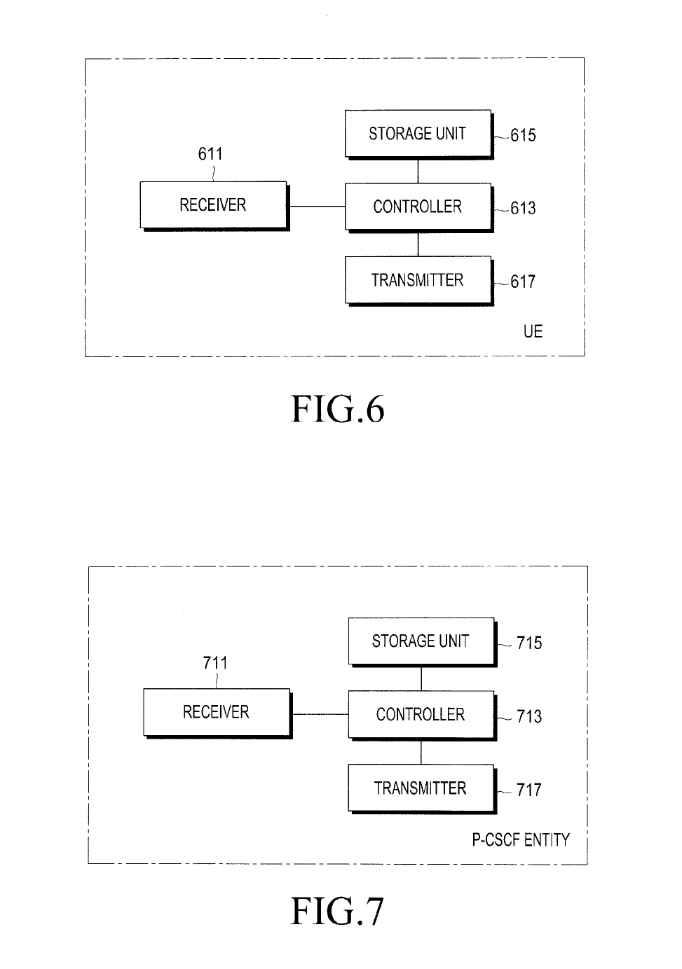

FIG. 6 is a block diagram schematically illustrating an internal structure of a UE in an IMS according to an exemplary embodiment of the present invention.

Referring to FIG. 6, the UE includes a receiver 611, a controller 613, a storage unit 615 and a transmitter 617. While the UE may include additional components, these components are omitted for clarity.

The controller 613 controls the overall operation of the UE. The controller 613 controls the UE to determine whether a PLMN(s) supports a NOVES and media types supported in each access network operated by the PLMN(s). The operation of determining whether the PLMN(s) supports the NOVES and the media types supported in each of the access networks operated by the PLMN(s) is performed in the manner described before with reference to FIGS. 2 to 5, so the detailed description will be omitted herein.

The receiver 611 receives messages from a P-CSCF entity under control of the controller 613.

The storage unit 615 stores the messages received by the receiver 611 and data for an operation of the UE.

The transmitter 617 transmits messages to the P-CSCF entity under the control of the controller 613.

While the receiver 611, the controller 613, the storage unit 615, and the transmitter 617 are shown in FIG. 6 as separate units, it is to be understood that this is for merely convenience of description. The receiver 611, the controller 613, the storage unit 615, and the transmitter 617 may be incorporated into a single unit.

FIG. 7 is a block diagram schematically illustrating an internal structure of a P-CSCF entity in an IMS according to an exemplary embodiment of the present invention.

Referring to FIG. 7, the P-CSCF entity includes a receiver 711, a controller 713, a storage unit 715, and a transmitter 717. While the P-CSCF entity may include additional components, these components are omitted from the drawing for clarity.

The controller 713 controls the overall operation of the P-CSCF entity. The controller 713 controls the P-CSCF entity to notify whether a PLMN(s) supports a NOVES, and media types supported in each access network operated by the PLMN(s). The operation of notifying whether the PLMN(s) supports the NOVES, and the media types supported in each of the access networks operated by the PLMN(s), is performed in the manner described before with reference to FIGS. 2 to 5, so the detailed description will be omitted herein.

The receiver 711 receives messages from a home S-CSCF entity and a UE under a control of the controller 713.

The storage unit 715 stores the messages received by the receiver 711 and data for an operation of the P-CSCF entity.

The transmitter 717 transmits messages to the home S-CSCF entity and the UE under the control of the controller 713.

While the receiver 711, the controller 713, the storage unit 715, and the transmitter 717 are shown in FIG. 7 as separate units, it is to be understood that this is for merely convenience of description. In other words, the receiver 711, the controller 713, the storage unit 715, and the transmitter 717 may be incorporated into a single unit.

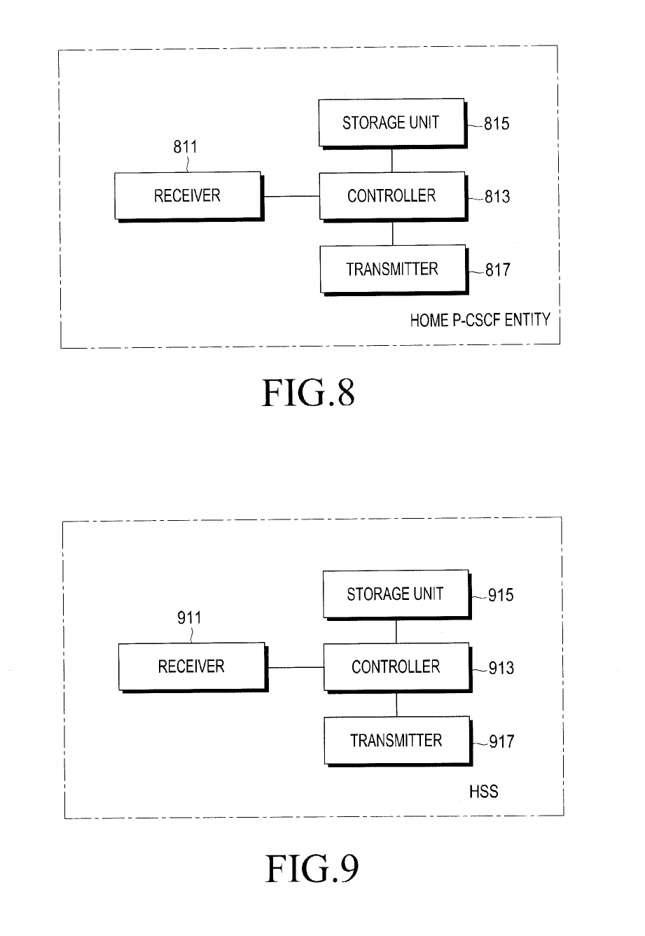

FIG. 8 is a block diagram schematically illustrating an internal structure of a home S-CSCF entity in an IMS according to an exemplary embodiment of the present invention.

Referring to FIG. 8, a home S-CSCF entity includes a receiver 811, a controller 813, a storage unit 815, and a transmitter 817. While the home S-CSCF entity may include additional components, these components are omitted from the drawings for clarity.

The controller 813 controls the overall operation of the home S-CSCF entity. The controller 813 controls the home S-CSCF entity to notify whether a PLMN(s) supports a NOVES, and media types supported in each access network operated by the PLMN(s). The operation of notifying whether the PLMN(s) supports the NOVES, and the media types supported in each of the access networks operated by the PLMN(s) is performed in the manner described before with reference to FIGS. 2 to 5, so the detailed description will be omitted herein.

The receiver 811 receives messages from a P-CSCF entity and an HSS under a control of the controller 813.

The storage unit 815 stores the messages received by the receiver 811 and data for an operation of the home S-CSCF entity.

The transmitter 817 transmits messages to the P-CSCF entity and the HSS under the control of the controller 813.

While the receiver 811, the controller 813, the storage unit 815, and transmitter 817 are shown in FIG. 8 as separate units, it is to be understood that this is for merely convenience of description. In other words, the receiver 811, the controller 813, the storage unit 815, and the transmitter 817 may be incorporated into a single unit.

FIG. 9 is a block diagram schematically illustrating an internal structure of an HSS in an IMS according to an exemplary embodiment of the present invention.

Referring to FIG. 9, the HSS includes a receiver 911, a controller 913, a storage unit 915, and a transmitter 917. While the HSS may include additional components, these components are omitted from the drawings for clarity.

The controller 913 controls the overall operation of the HSS. The controller 913 controls the HSS to notify whether a PLMN(s) supports a NOVES, and media types supported in each access network operated by the PLMN(s). The operation of notifying whether the PLMN(s) supports the NOVES, and the media types supported in each of the access networks operated by the PLMN(s) is performed in the manner described before with reference to FIGS. 2 to 5, so the detailed description will be omitted herein.

The receiver 911 receives messages from a home S-CSCF entity under a control of the controller 913.

The storage unit 915 stores the messages received by the receiver 911 and data for an operation of the HSS.

The transmitter 917 transmits messages to a home S-CSCF entity under the control of the controller 913.

While the receiver 911, the controller 913, the storage unit 915, and transmitter 917 are shown in FIG. 9 as separate units, it is to be understood that this is for merely convenience of description. The receiver 911, the controller 913, the storage unit 915, and the transmitter 917 may be incorporated into a single unit.

As is apparent from the foregoing description, exemplary embodiments of the present invention enable notifying a UE whether a serving PLMN supports a NOVES, and also notifying the UE of a media type which the serving PLMN supports thereby the UE may receive a NOVES call with a media type which the UE wants to receive.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for receiving an emergency call by a User Equipment (UE) in a mobile communication system, the method comprising:
transmitting, to a Proxy-Call Session Control Function (P-CSCF) entity, a first message including first information indicating that the UE requests an emergency call; and
receiving, from the P-CSCF entity, a second message including second information indicating whether a serving Public Land Mobile Network (PLMN) supports a Non Voice Emergency Service (NOVES), and indicating a media type which the serving PLMN supports.

2. The method as claimed in claim 1, wherein the first message is a REGISTER message, and the second message is a 200ok message, or
wherein the first message is an INVITE message, and the second message is an alternative services message.

3. The method as claimed in claim 1, wherein the first information further comprises information indicating that the UE supports the NOVES, and information indicating a media type of a NOVES call which the UE wants to connect.

4. A method for providing an emergency call by a Home Subscriber Server (HSS) in a mobile communication system, the method comprising:
performing an authentication process with a Serving-Call Session Control Function (S-CSCF) entity if the S-CSCF entity receives a first message including first information indicating that a User Equipment (UE) requests an emergency call; and
if the authentication process succeeds, transmitting, to the S-CSCF entity, a second message including second information indicating whether a serving Public Land Mobile Network (PLMN) supports a Non Voice Emergency Service (NOVES), and indicating a media type which the serving PLMN supports.

5. The method as claimed in claim 4, wherein the first message is a REGISTER message, and the second message is a 200ok message, or
wherein the first message is an INVITE message, and the second message is an alternative services message.

6. The method as claimed in claim 4, wherein the first information further comprises information indicating that the UE supports the NOVES, and information indicating a media type of a NOVES call which the UE wants to connect.

7. A User Equipment (UE) in a mobile communication system, the UE comprising:
a transmitter for transmitting, to a Proxy-Call Session Control Function (P-CSCF) entity, a first message including first information indicating that the UE requests an emergency call; and
a receiver for receiving, from the P-CSCF entity, a second message including second information indicating whether a serving Public Land Mobile Network (PLMN) supports a Non Voice Emergency Service (NOVES), and indicating a media type which the serving PLMN supports.

8. The UE as claimed in claim 7, wherein the first message is a REGISTER message, and the second message is a 200ok message, or
wherein the first message is an INVITE message, and the second message is an alternative services message.

9. The UE as claimed in claim 7, wherein the first information further comprises information indicating that the UE supports the NOVES, and information indicating a media type of a NOVES call which the UE wants to connect.

10. A Home Subscriber Server (HSS) in a mobile communication system, the HSS comprising:
a controller for performing an authentication process with a Serving-Call Session Control Function (S-CSCF) entity if the S-CSCF entity receives a first message including first information indicating that a User Equipment (UE) requests an emergency call; and
a transmitter for transmitting, to the S-CSCF entity, a second message including second information indicating whether a serving Public Land Mobile Network (PLMN) supports a Non Voice Emergency Service (NOVES), and indicating a media type which the serving PLMN supports, if the authentication process succeeds.

11. The HSS as claimed in claim 10, wherein the first message is a REGISTER message, and the second message is a 200ok message, or
wherein the first message is an INVITE message, and the second message is an alternative services message.

12. The HSS as claimed in claim 10, wherein the first information further comprises information indicating that the UE supports the NOVES, and information indicating a media type of a NOVES call which the UE wants to connect.

13. A method for receiving an emergency call by a User Equipment (UE) in a mobile communication system, the method comprising:
transmitting, to a Proxy-Call Session Control Function (P-CSCF) entity, one of a first message including information indicating that the UE requests an emergency call and supports a Non Voice Emergency Service (NOVES), and a second message including information indicating that the UE requests the emergency call and supports the NOVES, and indicating a media type of a NOVES call which the UE wants to connect;
receiving a third message including information indicating a media type which a serving Public Land Mobile Network (PLMN) supports from the P-CSCF entity if the first message is transmitted; and
receiving a fourth message including information indicating Visited Public Land Mobile Networks (VPLMNs) supporting the media type from the P-CSCF entity if the second message is transmitted.

14. The method as claimed in claim 13, wherein the first message and the second message are REGISTER messages, the third message is an unauthorized message, and the fourth message is a 200ok message.

15. A method for providing an emergency call by a Home Subscriber Server (HSS) in a mobile communication system, the method comprising:
performing an authentication process with a home Serving-Call Session Control Function (S-CSCF) entity if one of a first message including information indicating that a User Equipment (UE) requests an emergency call and supports a Non Voice Emergency Service (NOVES), and a second message including information indicating that the UE requests the emergency call and supports the NOVES, and indicating a media type of a NOVES call which the UE wants to connect is received at the home S-CSCF entity;
transmitting a third message including information indicating a media type which a serving Public Land Mobile Network (PLMN) supports to the home S-CSCF entity if the first message is received and the authentication process fails; and
transmitting a fourth message including a Visited Public Land Mobile Network (VPLMN) list including information on VPLMNs supporting the media type to the home S-CSCF entity if the second message is received and the authentication process succeeds.

16. The method as claimed in claim 15, wherein the first message and the second message are REGISTER messages, the third message is an unauthorized message, and the fourth message is a 200ok message.

17. A User Equipment (UE) in a mobile communication system, the UE comprising:
a transmitter for transmitting, to a Proxy-Call Session Control Function (P-CSCF) entity, one of a first message including information indicating that the UE requests an emergency call and supports a Non Voice Emergency Service (NOVES), and a second message including information indicating that the UE requests the emergency call and supports the NOVES, and indicating a media type of a NOVES call which the UE wants to connect; and
a receiver for receiving a third message including information indicating a media type which a serving Public Land Mobile Network (PLMN) supports from the P-CSCF entity if the first message is transmitted, and for receiving a fourth message including information indicating Visited Public Land Mobile Networks (VPLMNs) supporting the media type from the P-CSCF entity if the second message is transmitted.

18. The UE as claimed in claim 17, wherein the first message and the second message are REGISTER messages, the third message is an unauthorized message, and the fourth message is a 200ok message.

19. A Home Subscriber Server (HSS) in a mobile communication system, the HSS comprising:
a controller for performing an authentication process with a home Serving-Call Session Control Function (S-CSCF) entity if one of a first message including information indicating that a User Equipment (UE) requests an emergency call and supports a Non Voice Emergency Service (NOVES), and a second message including information indicating that the UE requests the emergency call and supports the NOVES, and indicating a media type of a NOVES call which the UE wants to connect is received at the home S-CSCF entity; and
a transmitter for transmitting a third message including information indicating a media type which a serving Public Land Mobile Network (PLMN) supports to the home S-CSCF entity if the first message is received and the authentication process fails, and for transmitting a fourth message including a Visited Public Land Mobile Network (VPLMN) list including information on VPLMNs supporting the media type to the home S-CSCF entity if the second message is received and the authentication process succeeds.

20. The HSS as claimed in claim 19, wherein the first message and the second message are REGISTER messages, the third message is an unauthorized message, and the fourth message is a 200ok message.
